(19) United States
(12) Patent Application Publication
(10) Pub. No.: US 2015/0044939 A1
(43) Pub. Date: Feb. 12, 2015

(54) Deer Rattler and Method of Use

(71) Applicants: William Meter, Dansville, NY (US); Brian Foresman, Muncy, PA (US)

(72) Inventors: William Meter, Dansville, NY (US); Brian Foresman, Muncy, PA (US)

(21) Appl. No.: 13/962,290

(22) Filed: Aug. 8, 2013

(51) Int. Cl. A01M 31/00

(52) U.S. Cl. CPC A01M 31/004
USPC 446/419

(57) ABSTRACT

A deer rattler is an apparatus that can be used in one hand. The deer rattler has a container filled with a plurality of rattling balls. As a user shakes the container, the plurality of rattling balls are set in motion and knock into each other producing an audible noise that mimics two or more deer antlers clashing together. This recreation of deer sparring attracts deer within hearing range by spurring their curiosity. The volume of the audible noise can be varied according to the force with which the container is rattled. A silencer can be inserted into the container in order to prevent motion of the plurality of rattling balls for quieter transport of the device. The deer rattler also has a carrying case which assists in the transport of the container, as well as helps to conceal the container through the use of a camouflage surface.

### FIELD OF THE INVENTION

The present invention relates generally to a hunting device. More specifically, the present invention is a noise maker that is used to attract deer by mimicking the sounds produced from two or more deer clashing antlers together. Furthermore, the present invention can be used with only one hand.

### BACKGROUND OF THE INVENTION

When deer hunting, it is common for hunters to attempt to mimic the natural sounds of deer in an effort to attract the deer to the hunter's location. The sound of clashing deer antlers is known to attract other deer as it spurs their interest. As such, game calls and rattlers are often used to recreate sparring matches between two deer. Game calls are used to mimic the grunts and wheezing of an individual deer, while rattlers are used to mimic the sound of deer antlers clashing together. While game calls can often be manipulated with one hand or no hands, rattlers often require two hands for use as they require the user to strike two pieces of equipment together. If both of a hunter's hands are occupied, then the hunter cannot have their gun or bow ready to fire when the deer comes within range. Once the deer is within range the hunter must lower the rattler and ready their gun or bow in position. Resultantly, the time in which the hunter can fire a shot is significantly delayed. Additionally, movement of the hunter during this time may alert the deer and scare the deer away.

Therefore it is the object of the present invention to provide a deer rattler that can be used in a single hand. The deer rattler consists of a container that is filled with a plurality of rattling balls. By shaking the container, the plurality of rattling balls are set in motion and knock into one another, creating an audible noise that mimics the clashing together of deer antlers. The volume of the device is dependent on the force with which the container is rattled. As the container can be shaken with one hand, the hunter can have their gun in a more accessible position to fire when a deer comes into range, than can be done with traditional rattlers. The container can also be operated while sleeved within a carrying case. The carrying case provides a method of attaching the deer rattler to an individual for ease of access and transport, as well as a camouflage surface to help reduce the visibility of the deer rattler. A silencer is also provided, which prevents motion of the rattling balls within the container for quieter transport.

### BRIEF DESCRIPTION OF THE DRAWINGS

FIG. 1 is a perspective view of the container partially sleeved within the carrying case.

FIG. 2 is a front sectional view of the container fully sleeved in the carrying case and the silencer removed.

FIG. 3 is a front sectional view depicting the inner diameter of the tubular body and the individual diameter of each of the plurality of rattling balls.

FIG. 4 is a front sectional view depicting the guiding length of the guiding volume and the combined diameter of the plurality of rattling balls.

FIG. 5 is a front sectional view of the container fully sleeved in the carrying case with the silencer positioned within the guiding volume.

FIG. 6 is a perspective view of the carrying case in an alternative embodiment.

FIG. 7 is a flowchart depicting the method of using the deer rattler.

FIG. 8 is a flowchart elaborating on step (1) shown in the flowchart of FIG. 7.

FIG. 9 is a flowchart elaborating on step (5) shown in the flowchart of FIG. 7.

### DETAIL DESCRIPTIONS OF THE INVENTION

All illustrations of the drawings are for the purpose of describing selected versions of the present invention and are not intended to limit the scope of the present invention.

The present invention is a deer rattler, which is used to mimic the sound produced from the clashing together of deer antlers. The deer rattler comprises a container 1, a plurality of rattling balls 2, a silencer 3, and a carrying case 4. The container 1 provides a housing for the plurality of rattling balls 2, as well as the silencer 3, while the carrying case 4 provides a housing for the container 1. The plurality of rattling balls 2 is movably positioned within the container 1 such that each of the plurality of rattling balls 2 may traverse along the length of the interior of the container 1, when the silencer 3 is removed.

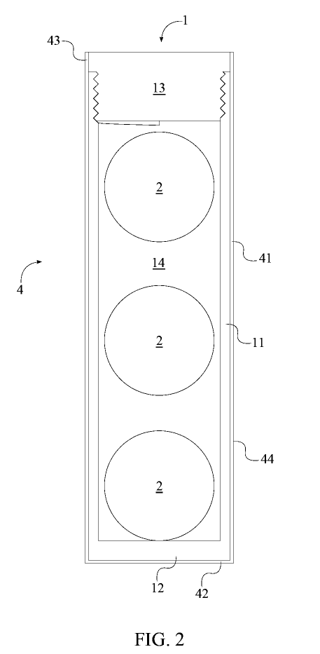

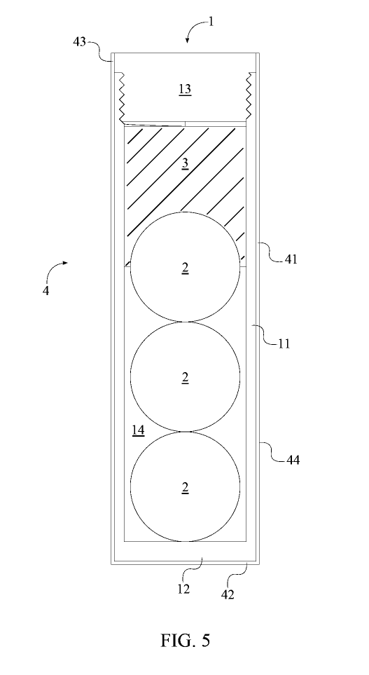

In reference to FIG. 2 and FIG. 5, the container 1 is a thin-walled cylindrical body that encases both the plurality of rattling balls 2 and the silencer 3. The container 1 comprises a tubular body 11, a first end cap 12, a second end cap 13, and a guiding volume 14. In the preferred embodiment of the present invention, the tubular body 11 is cylindrical, however, it is possible for the tubular body 11 to be any other shape. The first end cap 12 is adjacently connected to the tubular body 11, while the second end cap 13 is adjacently attached to the tubular body 11 opposite of the first end cap 12, such that the second end cap 13 is detachable. The first end cap 12 forms a fixed end of the container 1 that acts to retain the plurality of rattling balls 2 within the container 1. Contrarily, the second end cap 13 forms a removable end of the container 1. In this way, access to the interior of the container 1 is gained by removing the second end cap 13.

In further reference to FIG. 2, the guiding volume 14 is the interior volume of the container 1, and as such, the tubular body 11 delineates the guiding volume 14. In general, the guiding volume 14 has a circular cross section and traverses longitudinally through the entire length of the tubular body 11. As the guiding volume 14 is the interior of the container 1, the plurality of rattling balls 2 and the silencer 3 are positioned within the guiding volume 14 when housed in the container 1. The first end cap 12 and second end cap 13 each form a barrier about opposite ends of the guiding volume 14, sealing the plurality of rattling balls 2 and the silencer 3 within the guiding volume 14. The guiding volume 14 has a guiding length 141, being the distance between the first end cap 12 and the second end cap 13, which defines the length of the guiding volume 14 that can be occupied by the plurality of rattling balls 2 and/or the silencer 3. The guiding length 141 may vary depending on the particular types of end caps used. For example, a plug type end cap will occupy a portion of the guiding volume 14 as opposed to an end cap fitted around the tubular body 11.

The first end cap 12 can be formed as an extension of the tubular body 11 or can be connected to the tubular body 11 in any other manner. For example, the first end cap 12 can be fitted around the tubular body 11, or alternatively positioned partially or fully within the tubular body 11, such that at least part of the first end cap 12 extends into the guiding volume 14 Likewise, the second end cap 13 can be removably attached to the tubular body 11 in any manner, such as being fitted around or within the tubular body 11. In the preferred embodiment of the present invention, the second end cap 13 is threadably attached to the tubular body 11. The second end cap 13 has a threaded male portion, while the tubular body 11 has a threaded female portion. The threaded male portion of the second end cap 13 engages the threaded female portion of the tubular body 11 and rests within the guiding volume 14.

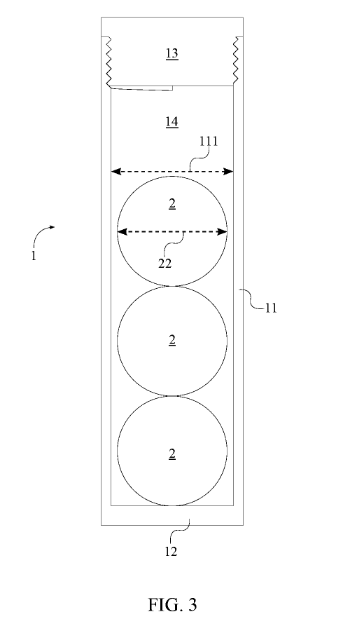

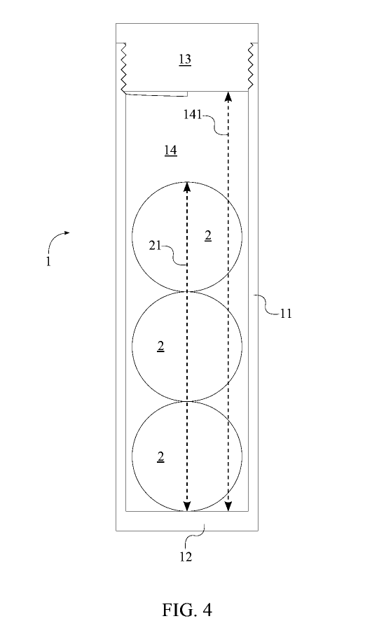

In reference to FIG. 3-4, the tubular body 11 has an inner diameter 111 and each of the plurality of rattling balls 2 has an individual diameter 22. Each of the plurality of rattling balls 2 is movably positioned within the guiding volume 14, such that each of the plurality of rattling balls 2 can traverse along the length of the container 1. As such, the individual diameter 22 of each of the plurality of rattling balls 2 is less than the inner diameter 111 of the tubular body 11. Additionally, the plurality of rattling balls 2 has a combined diameter 21 being the sum of the individual diameter 22 of each of the plurality of rattling balls 2 positioned within the guiding volume 14. The combined diameter 21 of the plurality of rattling balls 2 is less than the guiding length 141 of the guiding volume 14, such that there is unoccupied space within the guiding volume 14 when the silencer 3 is removed and thus allowing the plurality of rattling balls 2 to move from end to end of the container 1.

In the preferred embodiment of the present invention, the plurality of rattling balls 2 is inelastic. In this way, near elastic collisions occur between each of the plurality of rattling balls 2, as the plurality of rattling balls 2 traverses along the guiding volume 14. Each of these nearly elastic collisions produces an audible noise that mimics the sound of two deer antlers clashing together. By shaking the container 1 up and down, side to side, etc., a hunter can recreate the sounds of two deer establishing dominance over one another. This will cause intrigue in deer within hearing range and encourage said deer to investigate the source of the sound, thus bringing the deer within range of the hunter. The amount of force used to shake the deer rattler determines the volume of the audible noise created (i.e. the greater the force, the greater the volume).

In reference to FIG. 5, the silencer 3 is used to prevent the plurality of rattling balls 2 from colliding with one another in order to allow for quieter transport of the container 1. The diameter of the silencer 3 is approximately equal to the inner diameter 111 of the tubular body 11, and thus, when in use, the silencer 3 is snuggly positioned within the guiding volume 14. More specifically, when inserted into the guiding volume 14, the silencer 3 is positioned snuggly between the second end cap 13 and the plurality of rattling balls 2. By filling the previously unoccupied length of space within the guiding volume 14, the silencer 3 inhibits the motion of the plurality of rattling balls 2 along the guiding volume 14. The silencer 3 can be readily removed from or inserted into the guiding volume 14 as desired by detaching the second end cap 13 from the tubular body 11.

While the silencer 3 can be constructed from any pliable or rigid material, the silencer 3 is constructed from a foam material in the preferred embodiment of the present invention. The foam material offers lightweight construction of the silencer 3 and provides a dampener means that can be easily inserted into or removed from the guiding volume 14. Additionally, the construction of a silencer 3 from a foam material allows the silencer 3 to be easily compressed and stored in a pocket, bag, etc. when removed from the container 1. A portion of the silencer 3 may be shaped to receive a portion of the plurality of rattling balls 2 in order to inhibit side to side motion of the plurality of rattling balls 2, thus preventing contact between the plurality of rattling balls 2 and the tubular body 11. It is also possible for more than one silencer 3 to be used (i.e. a silencer 3 can be positioned in between each of the plurality of rattling balls 2 as well).

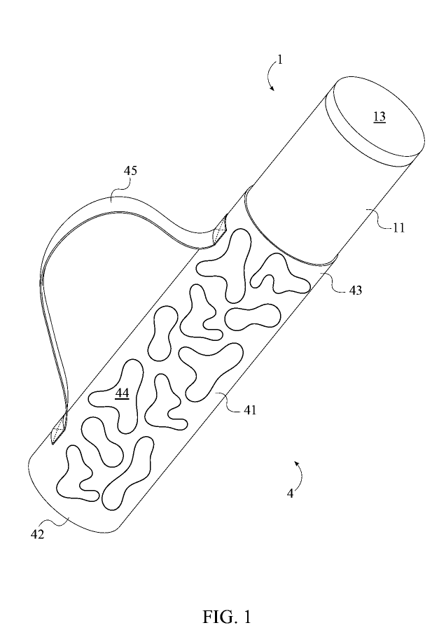

In reference to FIG. 1-2, the present invention includes a carrying case 4. The container 1 can be sleeved within the carrying case 4 both when in use and when out of use. The carrying case 4 allows the container 1 to more readily be transported while in the field, as well as conceals the container 1. The carrying case 4 comprises a side wall 41, an end wall 42, an open end 43, and a camouflage surface 44. The side wall 41 is a tubular piece of material that is shaped to receive the container 1. The end wall 42 is adjacently connected to the side wall 41, and together the side wall 41 and the end wall 42 form the body of the carrying case 4. The open end 43 is positioned opposite of the end wall 42 along the side wall 41. The open end 43 allows the container 1 to readily be placed in or removed from the carrying case 4, while the end wall 42 provides a base on which the container 1 may rest when sleeved within the carrying case 4.

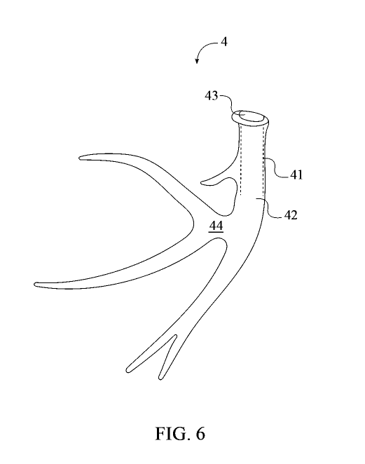

The camouflage surface 44 encompasses the side wall 41 and the end wall 42, forming the exterior of the carrying case 4. The camouflage surface 44 provides a disruptive pattern that breaks up the edges of the deer rattler, making the deer rattler less visible to on looking animals or humans. In the preferred embodiment of the present invention the camouflage surface 44 is permanent, however, it is possible for the camouflage surface 44 to be removable such that a camouflage surface 44 having one pattern can be interchanged with a camouflage surface 44 having a different pattern. In an alternative embodiment of the present invention, the camouflage surface 44 is in the shape of a deer antler, providing a unique stylistic appearance, as shown in FIG. 6.

The carrying case 4 also has a type of fastening device 45 in the preferred embodiment of the present invention. The fastening device 45 is connected to the side wall 41 and/or end wall 42 and allows the user to more readily transport the deer rattler. The fastening device 45 can be a strap, as shown in FIG. 1, hook, clip or any other device that allows the carrying case 4 to be temporarily attached to a person or another object. The carrying case 4 may also be designed such that the open end 43 can be temporarily sealed in order to prevent the container 1 from inadvertently being removed from the carrying case 4. A sealing mechanism such as a pull cord, zipper, snap, button, etc. can be provided along the open end 43 in order to secure the carrying case 4 closed.

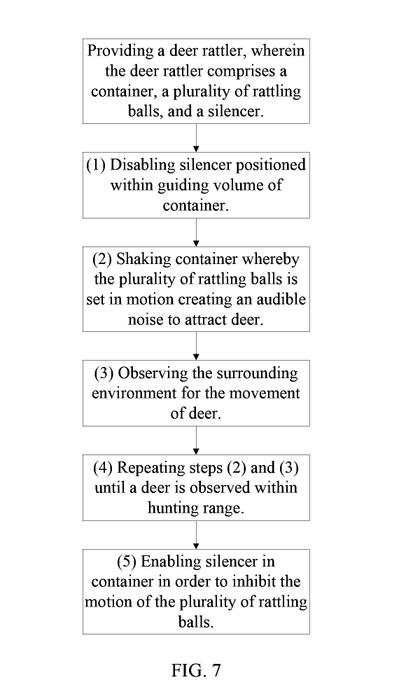

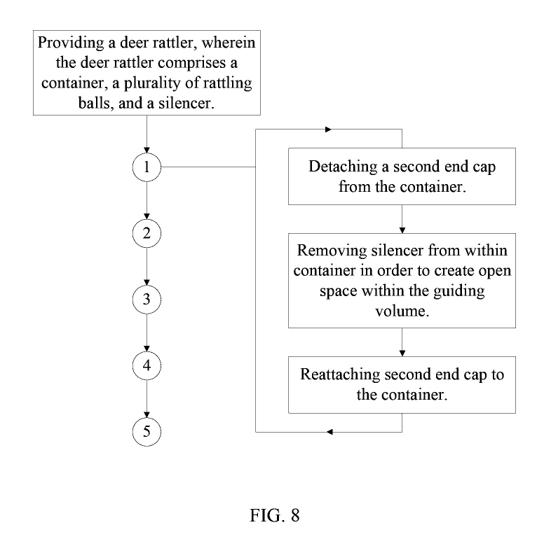

In reference to FIG. 7, the method of using the deer rattler is detailed in the proceeding paragraphs. First, the user must disable the silencer 3 positioned within the guiding volume 14 of the container 1. In reference to FIG. 8, this is accomplished by detaching the second end cap 13 from the container 1 and then removing the silencer 3 from within the container 1. By removing the silencer 3, open space is created within the guiding volume 14, permitting motion of the plurality of rattling balls 2. Once the silencer 3 has been removed, the second end cap 13 is reattached to the container 1.

With the silencer 3 disabled, the user then shakes the container 1, setting the plurality of rattling balls 2 in motion, the motion of which creates an audible noise to attract deer within hearing range. As the plurality of rattling balls 2 is set in motion, each of the plurality of rattling balls 2 is knocked into each other, which is driving force behind the created audible noise. Knocking the plurality of rattling balls 2 together with more force produces a louder audible noise, while knocking the plurality of rattling balls 2 together with less force produces a quieter audible noise. The audible noise created from knocking together the plurality of rattling balls 2 mimics sounds made from the clashing together of deer antlers, and thus reproduces two deer sparring or establishing dominance over one another.

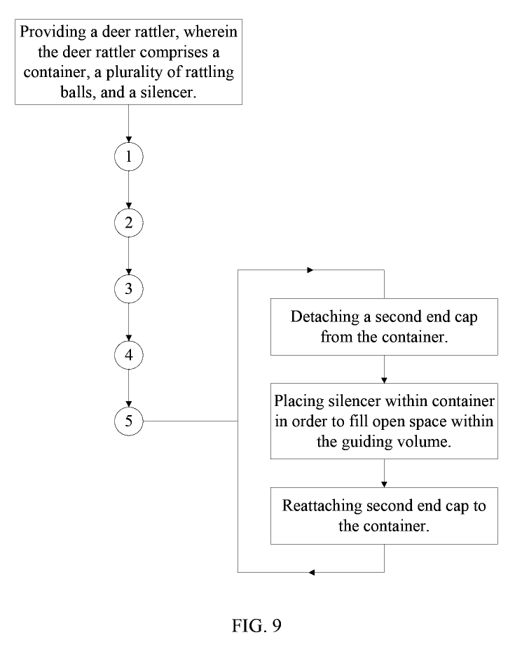

After shaking the container 1 for the desired length of time, the user then observes the surrounding environment for the movement of deer. The process of shaking the container 1 and observing the surrounding environment is continued until a deer is observed within hunting range. The user can then proceed to hunt the deer. When the deer rattler is no longer needed, the silencer 3 is enabled in the container 1 in order to inhibit the motion of the plurality of rattling balls 2. In reference to FIG. 9, this is accomplished by detaching the second end cap 13 from the container 1 and then placing the silencer 3 within the container 1 in order to fill the open space within the guiding volume 14. Once the silencer 3 has been inserted, the second end cap 13 is reattached to the container 1.

Although the invention has been explained in relation to its preferred embodiment, it is to be understood that many other possible modifications and variations can be made without departing from the spirit and scope of the invention as hereinafter claimed.

What is claimed is:

1. A deer rattler comprises:
a container;
a plurality of rattling balls;
a silencer;
a carrying case;
the container comprises a tubular body, a first end cap, a second end cap, and a guiding volume;
the carrying case comprises a side wall, an end wall, an open end, and a camouflage surface;
the first end cap being adjacently connected to the tubular body;
the second end cap being adjacently attached to the tubular body opposite of the first end cap;
the tubular body delineating the guiding volume; and
the plurality of rattling balls being movably positioned within the guiding volume.

2. The deer rattler as claimed in claim 1 comprises:
the plurality of rattling balls being inelastic;
a combined diameter for the plurality of rattling balls being less than a guiding length of the guiding volume; and
an individual diameter for each of the plurality of rattling balls being less than an inner diameter of the tubular body.

3. The deer rattler as claimed in claim 1 comprises:
the second end cap being threadably attached to the tubular body.

4. The deer rattler as claimed in claim 1 comprises:
the silencer being snuggly positioned within the guiding volume; and
the silencer being snuggly positioned in between the second end cap and the plurality of rattling balls, wherein motion of the plurality of rattling balls along the guiding volume is inhibited by the silencer.

5. The deer rattler as claimed in claim 1 comprises:
the silencer being a foam material.

6. The deer rattler as claimed in claim 1 comprises:
the side wall being adjacently connected to the end wall;
the open end being positioned opposite of the end wall along the side wall; and
the camouflage surface encompassing the side wall and the end wall.

7. The deer rattler as claimed in claim 1 comprises:
the camouflage surface being in the shape of a deer antler.

8. The deer rattler as claimed in claim 1 comprises:
the container being sleeved within the carrying case.

9. A deer rattler comprises:
a container;
a plurality of rattling balls;
a silencer;
a carrying case;
the container comprises a tubular body, a first end cap, a second end cap, and a guiding volume;
the carrying case comprises a side wall, an end wall, an open end, and a camouflage surface;
the first end cap being adjacently connected to the tubular body;
the second end cap being adjacently attached to the tubular body opposite of the first end cap;
the tubular body delineating the guiding volume;
the plurality of rattling balls being movably positioned within the guiding volume;
the plurality of rattling balls being inelastic;
a combined diameter for the plurality of rattling balls being less than a guiding length of the guiding volume;
an individual diameter for each of the plurality of rattling balls being less than an inner diameter of the tubular body;
the side wall being adjacently connected to the end wall;
the open end being positioned opposite of the end wall along the side wall; and
the camouflage surface encompassing the side wall and the end wall.

10. The deer rattler as claimed in claim 9 comprises:
the second end cap being threadably attached to the tubular body.

11. The deer rattler as claimed in claim 9 comprises:
the silencer being snuggly positioned within the guiding volume; and
the silencer being snuggly positioned in between the second end cap and the plurality of rattling balls, wherein motion of the plurality of rattling balls along the guiding volume is inhibited by the silencer.

12. The deer rattler as claimed in claim 9 comprises:
the silencer being a foam material.

13. The deer rattler as claimed in claim 9 comprises:
the camouflage surface being in the shape of a deer antler.

14. The deer rattler as claimed in claim 9 comprises:
the container being sleeved within the carrying case.

15. A method of using a deer rattler comprises the steps of:
providing a deer rattler, wherein the deer rattler comprises a container, a plurality of rattling balls, and a silencer;
(1) disabling the silencer positioned within a guiding volume of the container;
(2) shaking the container whereby the plurality of rattling balls is set in motion creating an audible noise to attract deer;
(3) observing the surrounding environment for the movement of deer;
(4) repeating steps (2) and (3) until a deer is observed within hunting range; and
(5) enabling the silencer in the container in order to inhibit the motion of the plurality of rattling balls.

16. The method of claim 15 wherein step (2) includes knocking the plurality of rattling balls into each other in order to create said audible noise.

17. The method of claim 15 wherein step (1) in disabling the silencer comprises the steps of:
detaching a second end cap from the container;
removing the silencer from within the container in order to create open space within the guiding volume; and
reattaching the second end cap to the container.

18. The method of claim 15 wherein step (5) in enabling the silencer comprises the steps of:
detaching a second cap from the container;
placing the silencer within the container in order to fill open space within the guiding volume; and
reattaching the second end cap to the container.
